(19) United States
(12) Patent Application Publication
(10) Pub. No.: US 2011/0017384 A1
(43) Pub. Date: Jan. 27, 2011

(54) COMPOSITE FUSELAGE FOR VEHICLES

(75) Inventors: Leo P. Oriet, Rochester Hills, MI (US); Andre Bocancea, Windsor (CA)

Correspondence Address: NAVISTAR CANADA, INC.;C/O Navistar, Inc., 4201 WINFIELD ROAD, P.O. BOX 1488, WARRENVILLE, IL, 60555, US

(73) Assignee: International Truck Intellectual Property Company, LLC, Warrenville, IL (US)

(21) Appl. No.: 12/507,390

(22) Filed: Jul. 22, 2009

(51) Int. Cl. B29C 53/60; B29C 53/66; B65H 81/08

(52) U.S. Cl. 156/175; 156/429

(57) ABSTRACT

A method of assembling a vehicle includes providing a mandrel that approximates the shape of a fuselage to be formed, winding a fiber around the mandrel by rotating the mandrel with a driver, heating the fiber to form the fuselage having a structural, hardened shell, removing the mandrel from the fuselage, and mounting the fuselage onto a frame rail of the vehicle.

### BACKGROUND

Embodiments described herein generally relate to vehicle body assemblies. More specifically, embodiments described herein relate to a composite fuselage for vehicles.

The current practice for bus construction provides for assembly of a body frame on top of a chassis and then applying a skin over the body frame to form a fuselage. First, a floor assembly is built. Then roof bows, stringers and drip rails are raised on the floor assembly to make the skeleton. Next, outer and inner sheet metal panels are applied to the skeleton enclosing the body.

Current fuselage assemblies for buses have over 600 different parts, many or all of which are designed, sourced, manufactured, inspected, shipped, delivered and assembled on an assembly line. The process involved in obtaining the parts before assembling them on the assembly line may be both time-consuming and costly. The large amount of parts for the fuselage may also have a large amount of materials. There is typically over 5000-feet of bulk linear material that is incorporated into the conventional fuselage, which may be a significant source of cost for manufacturing the bus or other vehicle.

The individual parts may be secured to each other with a combination of structural adhesive and fasteners, creating seams between the parts. Many seams may need to be closed, typically using over 200-gallons of materials, such as glue and seal. The parts may also be painted, and for further rust protection, a rust protection layer may also be added.

Further, the large amount of parts may result in a large amount of labor to assemble the parts into the bus fuselage, which may be another significant source of cost. Typically, the assembly of the conventional fuselage may require about 140-hours of labor. The workers may also be subject to highly repetitive and awkward assembly postures in constructing a conventional bus fuselage.

Additionally, the fuselage is conventionally made with heavy steel, which in turn, makes the bus heavier. The bus weight may be inversely proportional to the vehicle's fuel efficiency.

One bus incorporates lightweight composite fabrics that are formed into a fuselage by a vacuum-evacuated bag process. In this process, pre-impregnated composite fibers known as “prepreg” are positioned in a mold to form the desired shape. The bus fuselage has multiple separate pieces that would be bonded together to form the fuselage. To shape the fuselage and to develop a good bond between the pieces, the assembly may be covered with a plastic bag, creating a vacuum. After the vacuum, curing may take place at room temperature or in an oven. Curing time may range between 10 to 24 hours depending on the complexity of the part and the heat applied during the process. With the use of composite fabrics, the fabrics are positioned in the vacuum-bag mold, and the separate composite pieces are bonded together to form the fuselage.

### SUMMARY

A method of assembling a vehicle includes providing a mandrel that approximates the shape of a fuselage to be formed, winding a fiber around the mandrel by rotating the mandrel with a driver, heating the fiber to form the fuselage having a structural, hardened shell, removing the mandrel from the fuselage, and mounting the fuselage onto a frame rail of the vehicle.

### BRIEF DESCRIPTION OF THE DRAWINGS

FIG. 1 is an exploded side view of a vehicle assembly having chassis frame rails, a composite fiber fuselage and composite fiber side skirts.

FIG. 2 is a section view taken along line A-A of FIG. 1 of the vehicle assembly.

FIG. 3 is an exploded side view of a second embodiment of a vehicle assembly having a composite fiber frame rail tube, composite fiber side tubes, and the composite fiber fuselage of FIG. 1.

FIG. 4 is a section view taken along line B-B of FIG. 3 of the vehicle assembly.

FIG. 5 is an exploded side view of a third embodiment of a vehicle assembly having composite fiber frame rail tubes, composite fiber luggage tubes, and the composite fiber fuselage of FIG. 1.

FIG. 6 is a section view taken along line C-C of FIG. 5 of the vehicle assembly.

FIG. 7 is an exploded side view of a fourth embodiment of a vehicle assembly having a frame rail, composite fiber side tubes and the composite fiber fuselage of FIG. 1.

FIG. 8 is a section view taken along line D-D of FIG. 6 of the vehicle assembly.

FIG. 9 is a front perspective view of a mandrel for forming the fuselage of FIG. 1.

FIG. 10 is a front view of a fiber applicator assembly for applying a resin fiber to the mandrel of FIG. 9.

FIG. 11 is a perspective view of the fiber applicator assembly.

### DETAILED DESCRIPTION

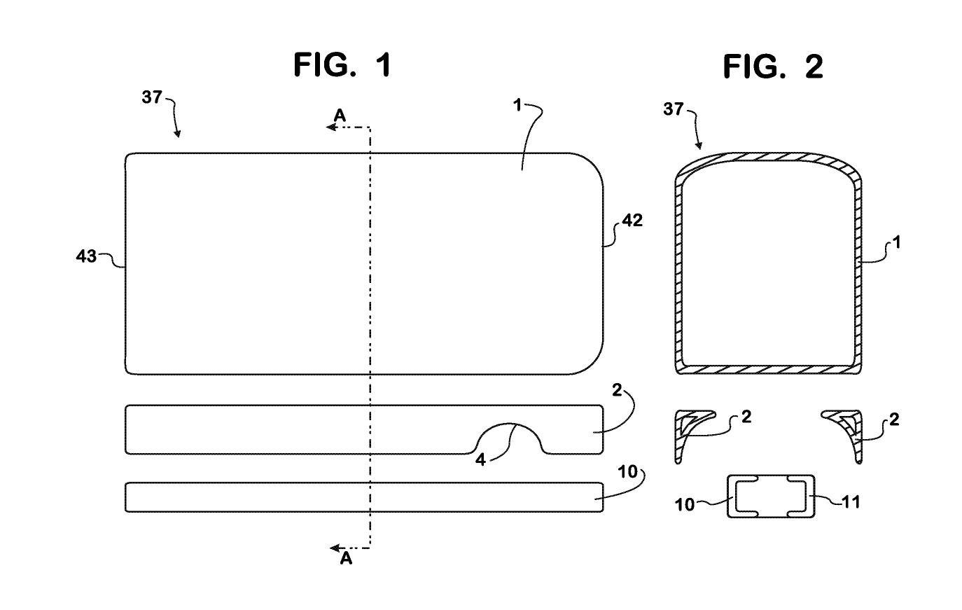

Referring now to FIG. 1 and FIG. 2, a first embodiment of a vehicle assembly is indicated generally at 37. The vehicle assembly 37 includes a fuselage 1 which may be formed in one piece from a rear surface 42 to a front opening 43. The fuselage 1 is shown having the shape of a fuselage for a bus, however other shapes of fuselage for other vehicles are possible. The rear surface 42 of the fuselage 1 of FIGS. 1 and 2 has rounded corners, which in this example serve as a rear end cap of a traditional North American school bus while the front opening 43 has sharper corners, designed to mate with a front bus end cap, however it is possible that the fuselage may have other shapes. The rear end cap or the front end cap may be glued to the fuselage 1. It is also possible for rear surface 42 to serve as the front of the bus and front opening 43 to mate with a rear end cap or cargo door opening.

From the rear surface 42 to the front surface 43, the fuselage 1 is formed of a composite material in a single, continuously formed piece having no joints. However, it is possible that the fuselage 1 can be formed in more than one-piece by the process described below, and the pieces can be joined together. The composite material forming the fuselage 1 may be in fiber form, and may include a resin-impregnated carbon fiber, fiberglass or any other composite material that may be available in fiber form. The fuselage 1 and any other component formed by the process described below with composite fiber is a structural fuselage or structural component.

In the vehicle assembly 37, the fuselage 1 may be mounted onto a left frame rail 10 and a right frame rail 11 made of steel or other conventional structural material. A left and a right side skirt 2 may be attached to the left frame rail 10 and the right frame rail 11 and to the fuselage 1. The side skirts 2 may have a wheel formation clearance 4 to permit the mounting of a wheel (not shown) to the left frame rail 10 and the right frame rail 11. The left and the right side skirts 2 may also be formed of the composite fiber material.

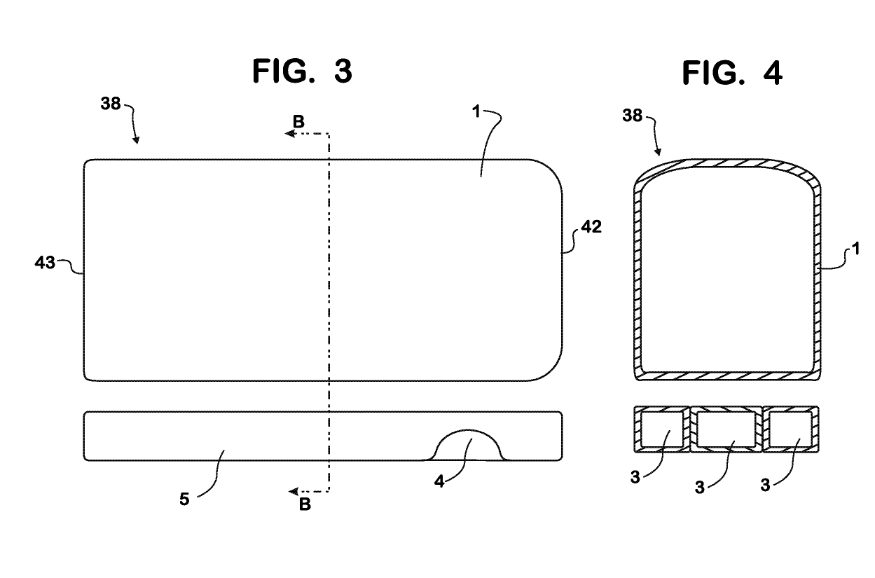

Referring now to FIG. 3 and FIG. 4, a second embodiment of vehicle assembly 38 includes the fuselage 1 mounted on a set of three structural composite fiber longitudinal tubular chassis frames, or frame rail tube 3 and side tubes 5. Frame rail tube 3 may replace the conventional frame rails 10 and 11 (FIGS. 1 and 2). Side tubes 5 may replace conventional non-structural steel side skirts and provide additional longitudinal structural reinforcement for the vehicle assembly 38. In addition to the fuselage 1 being formed of the composite fiber material, frame rail tube 3 and side tube 5 are also formed of the composite fiber material. The frame rail tube 3 is disposed between and engaged with the left and the right side tubes 5.

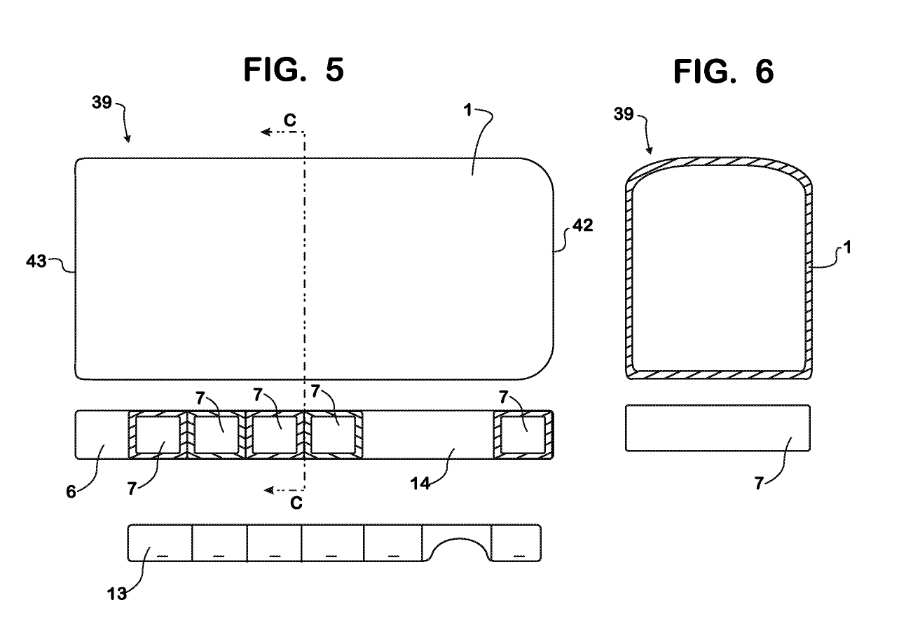

Referring now to FIG. 5 and FIG. 6, a third embodiment of a vehicle assembly is indicated at 39 and includes the fuselage 1 mounted on a shortened set of one or more, for example three, longitudinal structural composite frame rail tubes 14, which may have similar cross sections as frame rail tube 3 or side tube 5 of FIG. 4. A rear suspension (not shown) may be mounted to the frame rail tubes 14. At least one fuel tank 6 and at least one luggage tube 7 are disposed transversely along a common axis with the frame rail tubes 14 and have an orientation that is generally perpendicular to the longitudinal axis of the frame rail tubes 14. At least one luggage tube door 13 may be attached to the at least one luggage tube 7. In the vehicle assembly 39, the fuselage 1 and the luggage tubes 7 are formed of the composite fiber material. The fuel tank 6 may also be formed of composite fiber material.

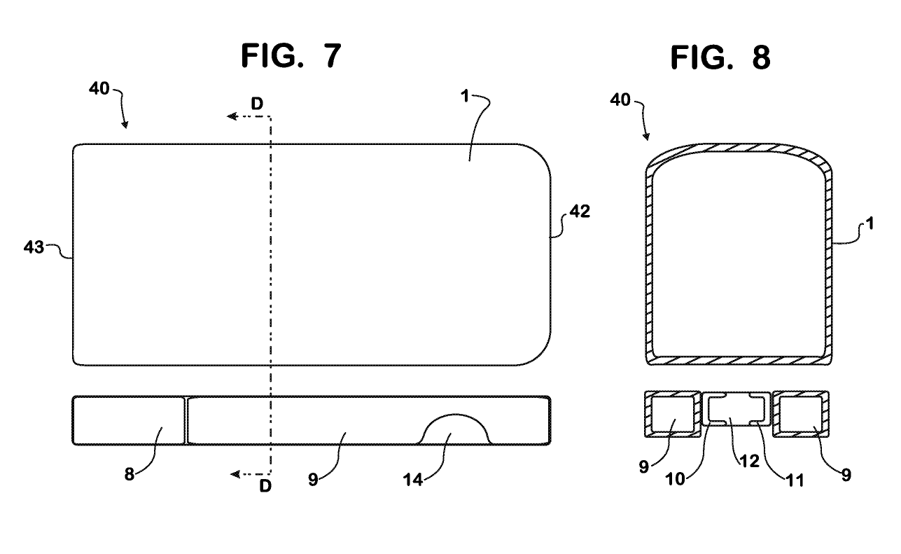

Referring now to FIG. 7 and FIG. 8, a fourth embodiment of a vehicle assembly is indicated generally at 40. The vehicle assembly 40 includes the fuselage 1 mounted on the conventional chassis left frame rail 10 and the right frame rail 11. A left and a right side tube 9 are attached to the left frame rail 10 and the right frame rail 11. A side saddle fuel tank 8 is mounted adjacent to each of the left and the right side tube 9. A cross member 12 extends between the left frame rail 10 and the right frame rail 11. In the vehicle assembly 40, the fuselage 1, the left side tube 9 and the right side tube 9 are all formed of the composite fiber material.

The various embodiments described above are exemplary embodiments of fuselage assemblies where a fuselage 1 formed of the composite fiber material is mounted on a vehicle which may have additional components also formed of the composite fiber material. However, it is possible that only the fuselage 1 is formed of the composite fiber material. Alternatively, it is possible that other components, including components not shown, may be formed of the composite fiber material.

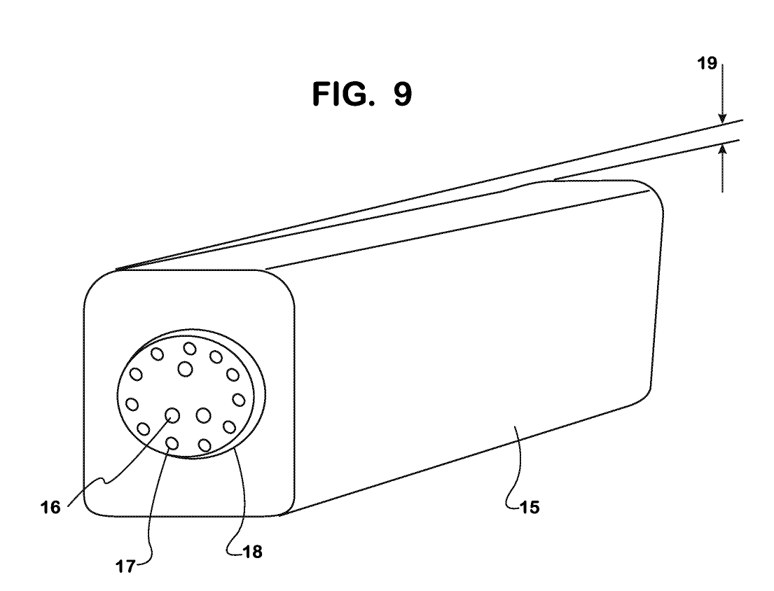

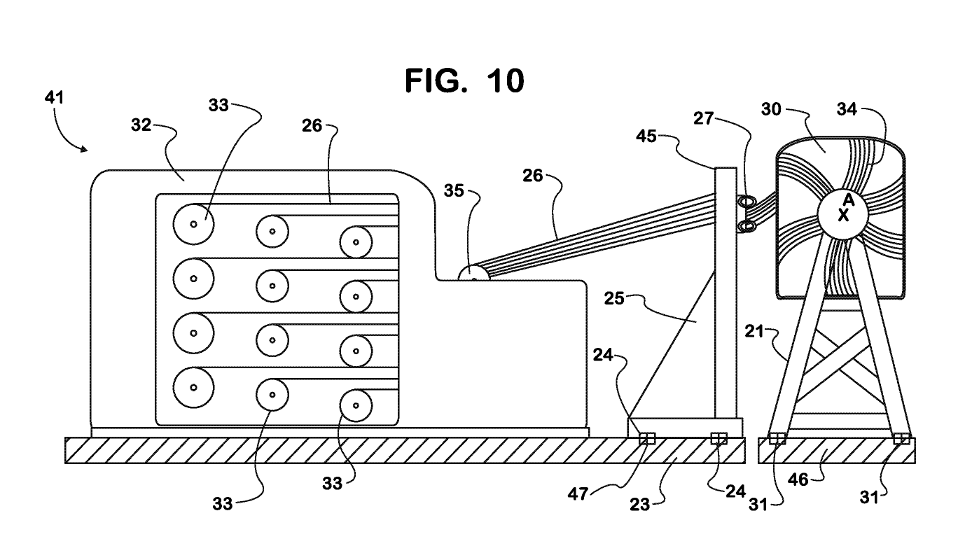

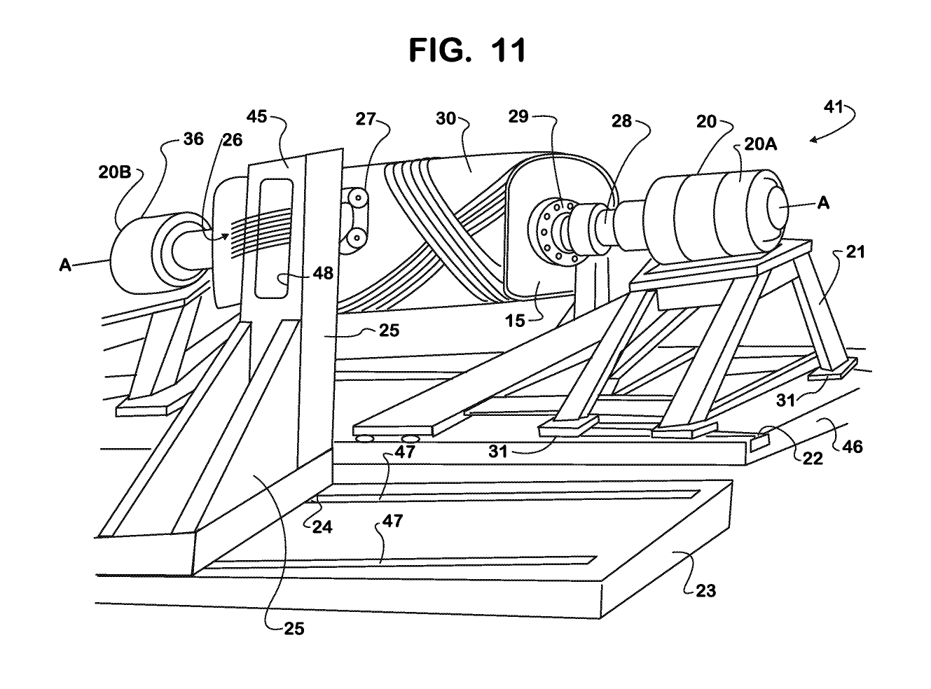

The process for forming a component will now be described with specific reference to forming the fuselage 1, however it should be appreciated that the process can be applied to other components. Referring now to FIG. 9 through FIG. 11, the process for forming the fuselage 1 includes winding a fiber 26, such as a resin-impregnated carbon fiber, fiberglass or any other fiber that is strong and stiff in tension, around a mandrel 15. Example fibers that are very strong and stiff in tension, include Boron, Carbon, Glass, Kevlar®, Nextel, Spectra, Alumina, and Silicon Carbide.

After analyzing the shape of the fuselage 1 and the material characteristics throughout the fuselage, such as by finite elemental analysis, the fibers 26 are selected in accordance with the appropriate strength, stiffness, heat resistance, corrosion resistance and other material properties, as well as cost considerations. Multiple fibers 26, such as about 100-fibers, may be applied at the same time. Within the multiple fibers 26 applied, multiple types of fibers made of different materials may be applied, although it is possible that only one type of fiber is applied.

If glass fibers 26 are used, the fibers may be formed drawing molten glass through small openings in a platinum die. The molten glass is then elongated mechanically, cooled and wound on a roll. The fibers 26 may be treated with silane or other silicon hybrid for improved wetting and bonding between the fiber and the matrix, which is the intertwined structure that is formed. The principal types of glass fibers 26 that may be used include: E-type: a calcium aluminoborosilicate glass, S-type: a magnesia-aluminuosilicate glass, and E-CR-type: a high performance glass fiber, although other fibers may be used.

If graphite or carbon fibers 26 are used, the fibers may be made by pyrolysis of organic precursors, commonly of polyacrylonitrile (PAN). Depending on the temperature of pyrolysis and the purity of the material, graphite or carbon fibers 26 will be produced. Carbon fibers 26 are generally 80 to 95% carbon while graphite fibers are usually more than 99% carbon.

The fuselage 1, or other components such as the frame rail tube 3, 14, the side tubes 5 and 9, the side skirts 2, the luggage tube 7, and the fuel tank 6, that are made by winding composite fiber around a mandrel 15 are strong, structural components. The mandrel 15 serves as a core around which the fiber 26 is shaped. The mandrel 15 is designed and built so that the shape of the mandrel approximates the interior shape of the fuselage 1, or the interior shape of any other component. In the case of the fuselage 1, the mandrel 15 may be about 50-feet long.

One or more seven-axis computer controlled fiber applicators 45 automatically dispense several unidirectional fibers 26. The fiber 26 is wound onto the rotating mandrel 15 in a predetermined geometric pattern 34. The winding process is conducted in a fiber applicator assembly 41 which may be fully or partially automated. To wind the fiber 26 around the mandrel 15, the mandrel is rotated with respect to spindles 27 that carry the fiber 26 from the fiber applicator 45, which applies the fiber to the mandrel. The spindles 27 are mounted on a side of the fiber applicator 45 adjacent the mandrel 15, and the fiber 26 may be fed through an opening 48 in the fiber applicator. The fiber applicator 45 may apply about 100-fibers to the mandrel 15 at the same time.

Rotation of the mandrel 15 is provided by a driver 20, such as an electric driver, that is selectively attachable to the mandrel 15 along a driver axis A. Extending from a first end of the driver 20A is drive shaft 28 that is selectively attachable to a mounting plate 18 of the mandrel 15. Fasteners 29 on the drive shaft may fasten the drive shaft 28 to the mounting plate 18. The mounting plate 18 may include aligning structure 16 such as protrusions to align with the drive shaft 18, and may also include mounting structure 17 such as threaded holes to receive the fasteners 29. At the second end of the driver 20B opposite of the drive shaft 28, a mandrel bearing 36 supports the rear surface of the mandrel 15. The driver 20 rotates the mandrel 15 with respect to the fiber applicator 45. In one embodiment, the mandrel 15 may tilt at an angle with respect to the axis A.

The driver 20 may also be displaceable along driver axis A and with respect to the spindle 27 on the fiber applicator 45. In one embodiment, the driver 20 is slidable on a driver track 22 with a sliding structure 21. A driver base plate 46 may define the driver track 22. The sliding structure 21 has at least one bearing 31 that engages the driver track 22 to slide both sides of the driver 20A, 20B, and in turn the mandrel 15, along driver axis A and with respect to the fiber applicator 45.

The fiber applicator 45 may also be displaceable parallel to the driver axis A and with respect to the mandrel 15. In one embodiment, the fiber applicator 45 has a support base 25 with at least one bearing 24 that is received in an applicator track 47. The applicator track 47 may have an orientation that is generally parallel with the driver axis A. An applicator base plate 23 may define the applicator track 47.

The spindle 27 applies the fiber 26 in layers across the outer surface of the mandrel 15. The spindle may be displaceable generally parallel to the driver axis A and with respect to the mandrel 15. The spindle 27 may be displaceable vertically in a direction transverse to the driver axis A and with respect to the applicator support base 25 and with respect to the mandrel 15. It is also possible that the spindle 27 is moveable towards and away from the mandrel 15. Providing a spindle 27 that is moveable with respect to the mandrel 15, the fiber 26 can be applied to the mandrel in a variety of different patterns 34. Further, providing relative motion between the mandrel 15 and the spindle 27, the fiber 26 can be applied to the mandrel in a variety of different patterns 34.

The fiber 26 is supplied through several spools 33. The fiber 26 may provided to the fiber applicator 45 by a fiber bath machine 32 that houses at least one spool 33, and about 100-spools, of fiber. The fiber bath machine 32 baths the fiber 26 in resin to impregnate the fiber with resin. The fiber 26 may be impregnated by passing the fiber through a polymer bath. This process may be modified by wrapping the mandrel 15 with a pre-impregnated fiber 26. A pulley 35 maintains the fiber 26 under tension while it is fed to the fiber applicator 45 for application to the mandrel 15. A protective coating or sizing may be applied to facilitate the passage of the fiber 26 through the machinery.

Generally, the highest stiffness and strength in the fuselage 1, or other components, is obtained when the fibers 26 are aligned in the direction of the tension force. The fiber applicator assembly 41 aligns the fibers 26 to maximize their strength though a process in which the resin and fibers are combined before application to the mandrel to develop a high strength to weight ratio.

Axi-symmetric components, such as rail tubes 3, 14, side tubes 5, 9, luggage tubes 7, fuel tanks 6 and the bus fuselage 1, and even non-symmetric bus components such as side skirts 2 are produced on a rotating mandrel. The fiber 26 is wrapped continuously around the mandrel 15 whether the components are axisymmetric or non-symmetric.

After all the layers of the fiber 26 have been applied, an uncured fiber fuselage 30 is formed. The uncured fiber fuselage 30, along with the mandrel 15 and the driver 20, are heated in a heater, such as an oven or autoclave (not shown), until the fiber fuselage is cured or hardened into the structural fuselage 1. The temperature and cure time varies and depends on the chemical composition of the resin and the fiber 26, and the thickness of the component being formed. Heat is used to reduce the curing time. Heat above 100 degrees F. may be applied to the mandrel 15 with internal hot water lines and an external oven or autoclave. The cure time is highly variable depending on the component being formed and the fibers used, however the cure time for a fuselage 1 may be less than 10-hours.

After hardening, the fuselage 1 is a continuous, hardened, structural shell which may have a smooth surface and no seams. The fuselage 1 and the mandrel 15 are moved out of the heater and the mandrel bearing 36 is removed from the mandrel. Then, the mandrel 15 is removed from the structural fuselage 1. It is possible that the mandrel 15 may include an ejector (not shown) to eject the mandrel from the fuselage 1, such as by pneumatically pushing against inside surface of the fuselage 1. Additionally, the mandrel 15 might have an angled surface 19 generally parallel to the axis A which helps with ejection of the mandrel from the fuselage. The mandrel may have a slight cone-shape that easily pulls out of the cured fuselage 1.

The interior cavity at the rear 42 of the fuselage 1 may be slightly smaller than the front opening 43, and may be about 1-inch smaller.

When the fuselage 1 is removed from the mandrel 15, the fuselage may be cut, for example to form window openings, doors, escape hatches, emergency exits, among other openings. The cutting may be accomplished at a cutting fixture (not shown), such as with a laser cutter or a high pressure water cutter. Additionally, the fuselage may be provided with fixtures, for example seat mounts, light packages, frame rails, suspension, among others. It is possible that automated or manual drill feed units (not shown) may drill holes into the fuselage to mount the fixtures. After or before any additional holes and fixtures are added, the fuselage 1 may be placed onto a chassis to form a bus. A front end cap and a back end cap may be assembled to the ends of the fuselage 1 to enclose the fuselage. Alternatively, it is contemplated that one of the ends can be integrally formed with the fuselage 1. The fuselage 1 is mounted onto the frame rail, either a conventional frame rail 10, 11 or a frame rail formed with composite fiber, such as frame rail tubes 3, 14, and side tubes 5, 9.

The fiber 26 forming the fuselage 1, or other components, may be provided with color, obviating the need to paint the fuselage or other component. For example, school bus fuselages may be provided with yellow fibers with yellow resin. Additionally, the fibers 26 may be highly corrosion resistant. Using the fibers 26, the weight of the bus may be reduced as much as ⅓ of the weight of a bus having a conventional fuselage. Additionally, many different fuselage shapes can be created using the fiber winding process.

What is claimed is:

1. A method of assembling a vehicle, the method comprising the steps of:
providing a mandrel that approximates shape of a fuselage to be formed;
winding a fiber around the mandrel by rotating the mandrel with a driver;
heating the fiber to form the fiber into a structural, hardened shell comprising the fuselage;
removing the mandrel from the fuselage; and
mounting the fuselage onto a frame rail of the vehicle.

2. The method of claim 1 wherein the driver has a drive shaft that is selectively attachable to the mandrel.

3. The method of claim 1 further comprising the step of feeding fiber to the mandrel with a spindle on a fiber applicator.

4. The method of claim 3 further comprising the step of displacing the mandrel along an axis of the driver.

5. The method of claim 4 further comprising sliding the driver on a driver track.

6. The method of claim 5 further comprising sliding a bearing of the driver on the driver track defined by a driver base plate.

7. The method of claim 3 further comprising displacing the spindle generally parallel to the driver axis and with respect to the mandrel.

8. The method of claim 3 further comprising displacing the spindle vertically with respect to the mandrel.

9. The method of claim 1 further comprising cutting the fuselage to form openings.

10. The method of claim 1 wherein the fuselage is formed in one continuous piece.

11. A fiber applicator assembly for forming a structural component of a bus or automotive vehicle, comprising:
a mandrel approximating the interior shape of the structural component;
a driver selectively attached to the mandrel for rotating the mandrel about a driver axis; and
a fiber applicator having a spindle for feeding a fiber to the mandrel, the spindle being displaceable with respect to the mandrel in a direction parallel to the driver axis and in a direction vertical and transverse to the driver axis.

12. The fiber applicator of claim 11 further comprising a driver track, wherein the driver is displaceable on the driver track in a direction parallel to the driver axis.

13. The fiber applicator of claim 11 further comprising an applicator track, wherein the fiber applicator is displaceable on the driver track in a direction parallel to the driver axis.

14. The fiber applicator of claim 11 further comprising a fiber bath machine that impregnates the fiber with resin, the fiber bath machine having a pulley for feeding the fiber to the fiber applicator under tension.

15. A method of assembling a vehicle, comprising:
providing a mandrel that approximates the shape of a fuselage to be formed;
winding a fiber around the mandrel by rotating the mandrel with a driver having a drive shaft that is selectively attachable to the mandrel;
applying the fiber with a fiber applicator by feeding the fiber from a spindle mounted on the fiber applicator to the mandrel;
displacing the spindle with respect to the mandrel;
heating the fiber to form the fiber into a hardened shell comprising the fuselage;
removing the mandrel from the fuselage; and
mounting the fuselage onto a frame rail of the vehicle.

16. The method of claim 15 wherein the mandrel further comprises:
a mounting plate having a mount structure, and the drive shaft is attached to the mounting plate with fasteners that are received by the mount structure.

17. The method of claim 15 wherein the driver further comprises:
a bearing that engages the mandrel on a side opposite from the drive shaft.

18. The method of claim 15 further comprising the step of:
forming at least one of a side skirt, a side rail and a luggage tube from a composite fiber material; and
attaching to the frame rail of the vehicle.

19. The method of claim 15 wherein the spindle displaces in a direction generally parallel to a drive axis and in a direction vertical and generally transverse to the drive axis.

20. The method of claim 15 wherein the fuselage is formed in a single, continuous piece.
